(19) United States
(12) Patent Application Publication
(10) Pub. No.: US 2013/0196211 A1
(43) Pub. Date: Aug. 1, 2013

(54) BATTERY HAVING CELL TAB CONNECTION STRUCTURE USING RESISTANCE WELDING

(71) Applicants: Tae Young Park, Daejeon (KR); Jeon Keun Oh, Seoul (KR); Hyo Sung Lee, Daejeon (KR); Ji Seok Lee, Incheon (KR)

(72) Inventors: Tae Young Park, Daejeon (KR); Jeon Keun Oh, Seoul (KR); Hyo Sung Lee, Daejeon (KR); Ji Seok Lee, Incheon (KR)

(73) Assignee: SK INNOVATION CO.,LTD., Seoul (KR)

(21) Appl. No.: 13/819,851

(22) PCT Filed: Sep. 1, 2011
(86) PCT No.: PCT/KR2011/006497

§ 371 Date: Apr. 15, 2013

(30) Foreign Application Priority Data
Sep. 1, 2010 (KR) 10-2010-0085522

(51) Int. Cl. H01M 2/30

(52) U.S. Cl. CPC H01M 2/30
USPC 429/156

(57) ABSTRACT

Disclosed herein is a battery having a cell tab connection structure made using resistance welding. A support member is interposed between the cells to support the cells. A terminal is placed on an upper surface of the support member. Tabs of each of the cells or both side edges of the terminal are bent, and the terminal is joined to the corresponding tabs of the cells by resistance welding.

### TECHNICAL FIELD

The present invention relates to a battery having a cell tab connection structure made using resistance welding.

### BACKGROUND ART

Generally, cells are classified into primary cells and secondary cells. Primary cells are cells which are not reusable after they are completely used up, because electricity is generated by an irreversible reaction. Dry cells, mercury cells, voltaic cells, etc. are representative examples of the primary cells. Secondary cells use reversible reaction so that they are repetitively reusable in such a way that they can be recharged. Lead cells, lithium-ion cells, Ni—Cd cells, etc. are representative examples of such reusable secondary cells. FIG. 1 is a view illustrating the notion of a typical lithium-ion cell which is one of the secondary cells. A lithium-ion cell and a lithium-ion polymer cell have the same structure and their only difference is the phase liquid/solid of the electrolyte. Furthermore, depending on the kind of cell, the material used for the electrolyte or the electrodes may be different from that shown in FIG. 1. As shown in FIG. 1, the lithium-ion cell includes a negative electrode 1 which is typically made of carbon, a positive electrode 2 which is typically made of a lithium compound, electrolyte 3 which is disposed between the two electrodes 1 and 2, and a wire 4 which connects the negative electrode 1 to the positive electrode 2. Lithium ions in the electrolyte 3 move to the negative electrode 1 when charging and to the positive electrode 2 when discharging. In the chemical reaction of the cell, each electrode emits or absorbs extra electrons. During this process, electrons flow along the wire 4, thus generating electricity. Although the lithium-ion cell has been illustrated, the basic principles and structures of other secondary cells are the same except the fact that the material of the electrode or electrolyte is different. In other words, as described above, the secondary cells typically include the negative electrode 1, the positive electrode 2, the electrolyte 3 and the wire 4.

Meanwhile, a secondary battery may comprise a single unit cell 10 including a negative electrode 1, a positive electrode 2, an electrolyte 3 and a wire 4. More generally, a secondary battery comprises a plurality of unit cells 10 which are connected to each other, each of which includes a negative electrode 1, a positive electrode 2, an electrolyte 3 and a wire 4. As such, the secondary battery contains a plurality of unit cells 10. Of course, the unit cells 10 are electrically connected to each other.

Typically, each of the cells which are contained in the secondary battery has a pair of tabs which protrude from the cells. Further, the secondary battery which contains the cells includes a pair of external terminal tabs which are connected to corresponding electrodes of the cells and are exposed to the outside. In other words, the external terminal tabs function as a negative electrode which is connected to the negative electrodes of the cells and as a positive electrode which is connected to the positive electrodes of the cells. Furthermore, a plurality of secondary batteries may be mainly connected to each other to form a battery pack, rather than each secondary battery being individually used as a single unit. Of course the external terminal tabs of the batteries are electrically connected to each other.

As mentioned above, several cells which are connected to each other form the single system of a battery. For this, a connector made of a conductor such as metal is used to connect the cells to each other. To assemble the connector to the cells, in the conventional art, a connection method using laser welding or bolt coupling was used. In the connection method using laser welding, the tabs must reliably come into close contact with the connector before the welding process is conducted. However, it is difficult to reliably bring the tabs into close contact with the connector. Thus, the error rate is comparatively high. Meanwhile, the connection method using bolt coupling is problematic in that the process of assembling the connector to the cells has a high level of difficulty, and the number of parts is increased. A lot of research aiming to solve these problems has taken place. It was however difficult to completely overcome the problems.

In Japanese Patent Laid-open Publication No. 2004-327310 (hereinafter, referred to as “prior art 1”), as shown in FIG. 2, a connection structure of a secondary battery and a connection method thereof was proposed, in which terminals between adjacent cells can be connected steadily. The terminals are connected to each other by a terminal connection member. The terminals and the terminal connection member are solder plated to connect and steady the terminals. In Korean Patent Laid-open Publication No. 2009-0095949 (hereinafter, referred to as “prior art 2”), as shown in FIG. 3, a conductive electrode terminal connection member was proposed, which electrically connects planar secondary cells constituting a battery module to each other. This connection member includes a left connection piece and a right connection piece which have insert slits so that electrode terminals of left and right cells are respectively connected to the left and right connection pieces in an insert coupling way. After the electrode terminals are inserted into the slits, the electrode terminals are bent and welded to the connection member. The contact stability of the prior art 1 and the prior art 2 is higher than that of the connection method using laser welding and have a reduced number of connection parts compared to that of the connection method using bolt coupling. However, as shown in FIGS. 2 and 3, the shapes of the connection members are complex, thus making the process of manufacturing the connection members difficult. Thereby, the assembly of a battery is also complicated.

Meanwhile, in Japanese Patent Laid-open Publication No. 2008-535158 (hereinafter, referred to as “prior art 3”), as shown in FIG. 4, a battery system was proposed, in which cells are connected in series just by stacking the cells one on top of another. In the prior art 3, electrode tabs provided on each cell are respectively bent to 90° upwards and downwards. Thus, when the cells are placed one on top of another, the tabs of the cells naturally come into contact with each other so that they are electrically connected to each other. The prior art 3 is advantageous in that the shape of the tab and the connection structure are simple. However, the only purpose of the connection structure of the prior art 3 is to connect cells provided in a single battery to each other. In other words, if the connection structure of the prior art 3 is used to connect batteries to each other, the contact stability therebetween is markedly reduced. Thus, the connection structure of the prior art 3 cannot be applied to a battery pack to connect cell tabs of the batteries of the pack to each other.

### DISCLOSURE OF INVENTION

### Technical Problem

Accordingly, the present invention has been made keeping in mind the above problems occurring in the prior art, and an object of the present invention is to provide a battery having a cell tab connection structure using resistance welding which can be simplified and can enhance the contact stability of the cell tab connection, thus reducing the numbers of processes and parts.

### Solution to Problem

In order to accomplish the above object, the present invention provides a battery having a cell tab connection structure using resistance welding, including a plurality of cells arranged in a predetermined pattern, each of the cells having a pair of tabs comprising a negative tab and a positive tab. Each of tabs has a planar shape, and the tabs protrude outside one side of the cell and are configured such that a planar surface of the negative tab and a planar surface of the positive tab are parallel to and face each other. The cells are arranged in at least one row in such a way that the planar surface of the negative tab of each of the cells faces parallel to the planar surface of the positive tab of the cell adjacent thereto. A support member is interposed between the cells to support the cells. A terminal is placed on an upper surface of the support member. The terminal is made of an electrical conductor. The tabs of each of the cells or both side edges of the terminal are bent, and the terminal is joined to the corresponding tabs of the cells by resistance welding.

Furthermore, when a direction in which the tabs protrude from the cell refers to a “tab-side”, the tabs of each of the cells may be bent outwards, and the adjacent tabs between the cells may be brought into close contact with the terminal placed on the tab-side surface of the support member interposed between the cells and be joined to the terminal by resistance welding.

Alternatively, when a direction in which the tabs protrude from the cell refers to a “tab-side”, the side edges of the terminal placed on the tab-side surface of the support member interposed between the cells may be bent towards the tabs of the cells, be brought into close contact with the corresponding tabs, and be joined to the tabs by resistance welding.

The terminal may be made of metal having a melting point of 600° C. or more.

The terminal may be plated with metal having a melting point of 600° C. or less.

The terminal may be used to sense voltage of the corresponding cell.

The terminal may have a planar shape.

The support member may be made of an electrical insulation material.

Each of the tabs or each of the side edges of the terminal may be bent to 90°.

### Advantageous Effects of Invention

As described above, in the present invention, the contact stability of a cell tab connection structure of a battery can be markedly enhanced compared to that of the conventional connection structure using laser welding or the like. Furthermore, due to use of resistance welding and the characteristics of the shape of the connection structure, the structural durability of the battery itself can also be markedly enhanced, compared to that of the conventional art.

In addition, the shape of a connection member itself is very much simpler than that of the conventional connection structure using the bolt coupling method or the conventional connection structure using a separate connection member. Therefore, the numbers of processes and parts can be reduced, and the level of difficulty of the process can also be markedly lowered. Thereby, the production cost of the battery is reduced, and the productivity is enhanced. Particularly, in the present invention, after a plurality of cells have been arranged and modularized, the resistance welding process is conducted to connect the cell tabs to each other. Accordingly, the stability of the module structure during the welding process can be increased. Thus, the productivity can be further enhanced.

### BRIEF DESCRIPTION OF DRAWINGS

FIG. 1 is a view showing the structure of a typical lithium-ion cell;

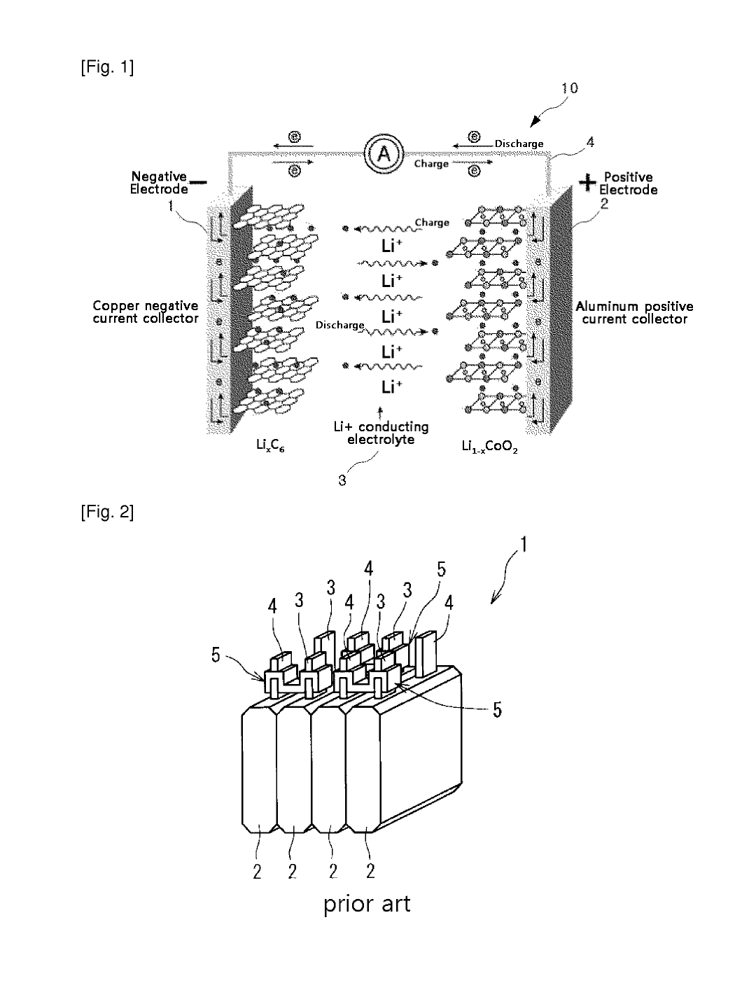

FIGS. 2 through 4 illustrate a conventional cell tab connection structure;

FIG. 5 is a perspective view showing the basic structure of a battery;

FIGS. 6 through 8 are views showing a first embodiment of a cell tab connection structure, according to the present invention; and

FIGS. 9 and 10 are views showing a second embodiment of a cell tab connection structure, according to the present invention.

### BEST MODE FOR CARRYING OUT THE INVENTION

Hereinafter, a battery having a cell tab connection structure using resistance welding according to the present invention will be described in detail with reference to the attached drawings.

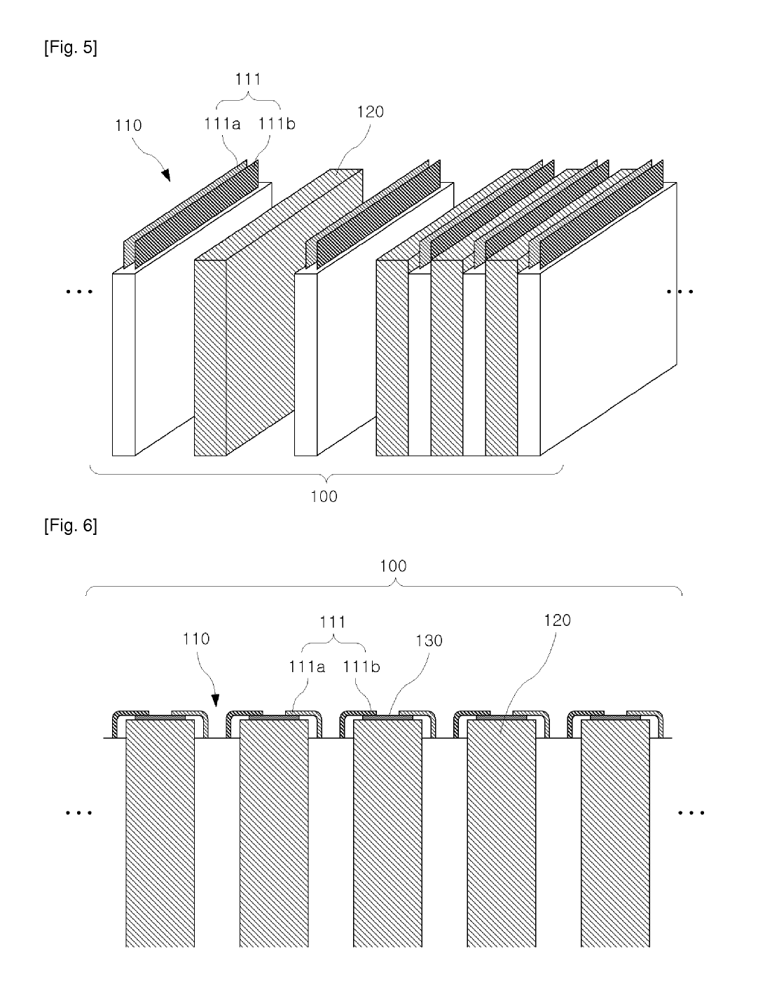

FIG. 5 is a perspective view showing a basic structure of a battery 100. As shown in the drawing, the battery 100 includes a plurality of cells 110 which are arranged and each of which has a pair of tabs 111. The tabs 111 of each cell 110 comprise a single negative tab 111a and a single positive tab 111b. In other words, each cell 110 has a pair of tabs 111. Each tab 111 has a planar shape. Further, the tabs 111 of each cell 110 are configured such that a planar surface of the negative tab 111a and a planar surface of the positive tab 111b are parallel to and face each other and portions thereof protrude outside one side of the cell 110. In an embodiment shown in the drawing of this specification, although the tabs 111 are illustrated as protruding upwards from the cell 110, the direction in which the tabs 111 protrude from the cell 110 is not limited to the upside. For example, the tabs 111 may protrude from either side of the battery 100. The cells 110 are arranged in at least one row in such a way that the planar surface of the negative tab 111a of each cell 110 is parallel to and faces the planar surface of the positive tab 111b of the cell 110 adjacent thereto. In detail, as shown in the drawing, each cell 110 typically has a flat rectangular shape. The two tabs 111 of each cell 110 extend from one of narrow surfaces of the cell 110 in a direction perpendicular to the narrow surface and parallel to wide surfaces of the cell 110. Further, the cells 110 are arranged in such a way that the wide surfaces thereof overlap each other. Therefore, as the cells 110 are arranged, all the tabs 111 of the cells 110 which are oriented parallel to the wide surfaces of the cells 110 are also naturally oriented parallel to each other.

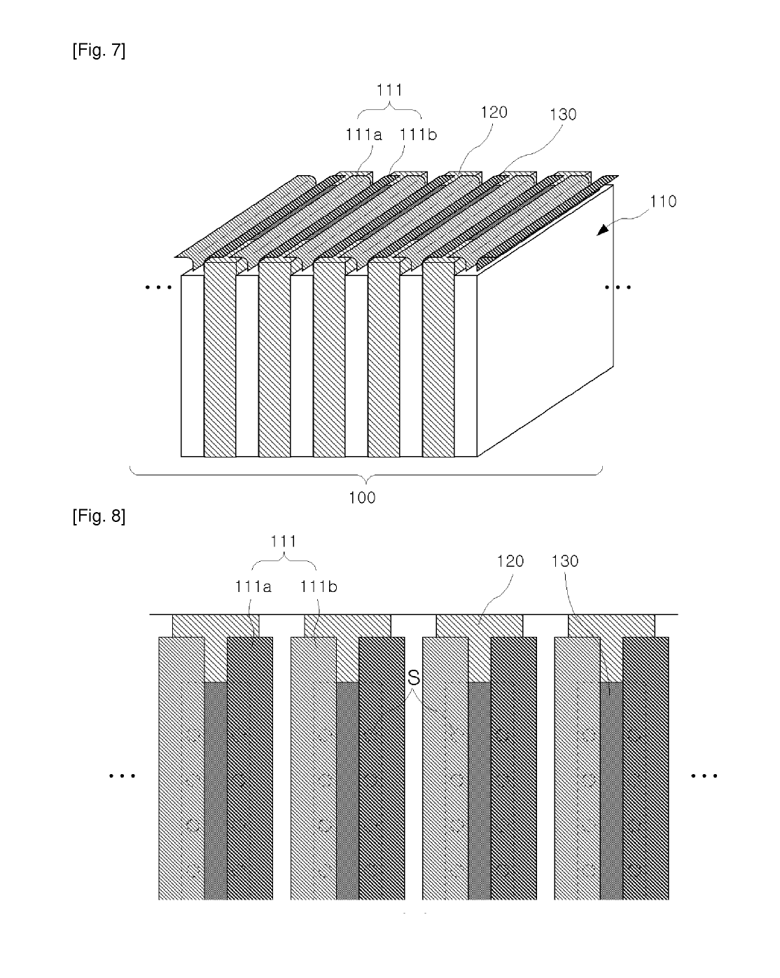

Based on this basic structure of the battery, the present invention provides the following structure for connecting the tabs 111 of the cells 110 to each other. FIG. 6 is a sectional view of the battery having a cell tab connection structure according to the present invention. FIGS. 7 and 8 are, respectively, a perspective view and a plan view illustrating the battery. A first embodiment of the cell tab connection structure in the battery according to the present invention will be described in detail with reference to FIGS. 6 through 8.

As shown in FIGS. 6 through 8, support members 120 for supporting the cells 110 are interposed between the cells 110 in such a way that a support member 120 is always between two cells 110. Such a support member is also used in the conventional typical battery, but in the case of the present invention, the width of the support member 120 is comparatively large. Each support member 120 may be made of a metal such as aluminum or, alternatively, it may be made of an electrical insulation material.

In the present invention, when a direction in which the tabs 111 protrude is called a “tab-side”, a terminal 130 made of an electrical conductor is provided on a tab-side surface of each support member 120. As shown in detail in the sectional view of FIG. 6, the two tabs 111 of each cell 110 are bent outwards in close contact with the corresponding terminals 130 provided on the tab-side surfaces of the support members 120 that are interposed between the cells 110. Preferably, each tab 111 is bent to 90°. As shown in FIG. 8, each tab 111 is thereafter joined to the corresponding terminal 130 by resistance welding (S), thus completing the connection between the tabs 111. Preferably, to facilitate the joining of the cell tab connection structure, the terminal 130 has a planar shape.

The cell tab connection structure will be explained in more detail below. As mentioned above, in the present invention, the two tabs 111 of each cell 110 are bent outwards. Here, because the cells 110 are arranged in such a way the wide surfaces thereof overlap each other, the end of the negative tab 111a of each cell 110 is located adjacent to the end of the positive tab 111b of the cell 110 that is located adjacent thereto. Further, the single support member 120 is interposed between the two neighboring cells 110, and the terminal 130 is provided on the support member 120. That is, the negative tab 111a of each cell 110 and the positive tab 111b of the cell 110 that is next to it are brought into close contact with the terminal 130 together. Therefore, the negative tab 111a of each cell 110 is electrically connected, by the terminal 130, to the positive tab 111b of the cell 110 that is next to it.

Moreover, after the tabs 111 are bent in close contact with the corresponding terminals 130, the tabs 111 are welded to the corresponding terminals 130 by resistance welding (S) to ensure the stability of contact therebetween, as shown in FIG. 8. The term “resistance welding” refers to a welding process, including: applying pressure to two metals; applying high tension currents to the metals to generate heat due to contact resistance at the junction between the metals and the specific resistance of the metals; and joining the metals together under the applied pressure after the metals are heated and melted by the generated heat. In resistance wielding, because the application of electric currents can be precisely controlled, the quality of the welding can be superior. Therefore, resistance welding is being widely used in a variety of fields. Typically, as shown in FIG. 8, the resistance welding is mainly performed in a spot welding way.

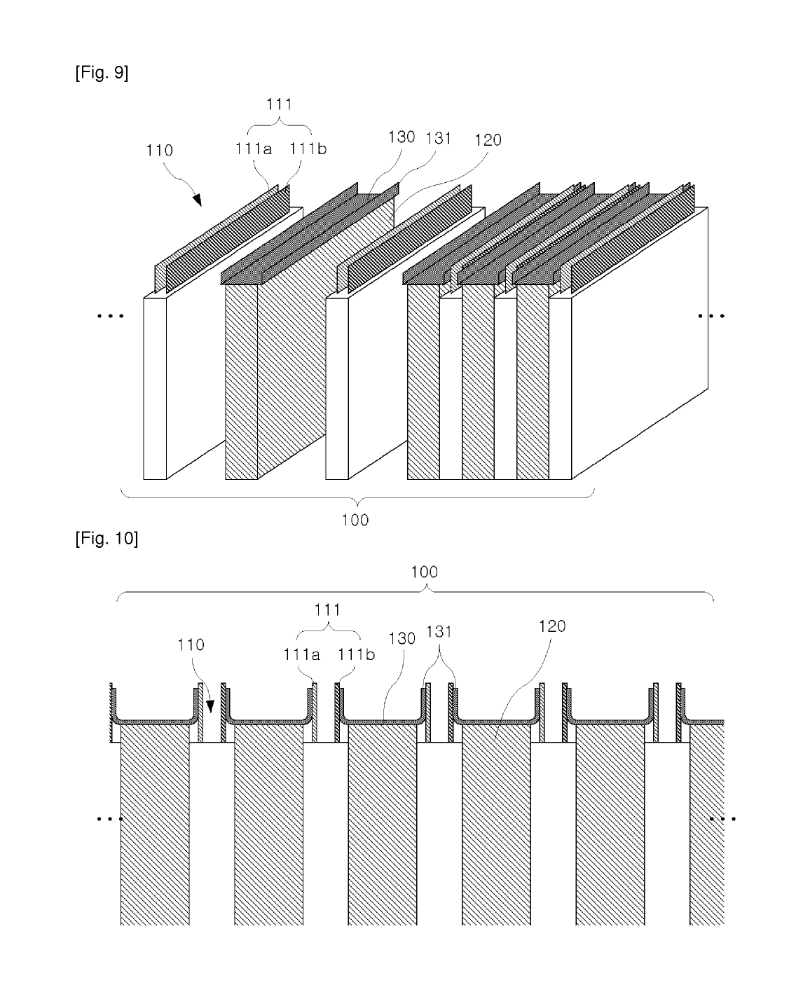

Hereinafter, a second embodiment of a cell tab connection structure of a battery according to the present invention will be described with reference to FIGS. 9 and 10.

Like the first embodiment of FIGS. 6 through 8, in the second embodiment, support members 120 are disposed between the cells 110 in such a way that a support member 120 is always between two cells 110. When a direction in which the tabs 111 protrude is called a “tab-side”, a terminal 130 is provided on a tab-side surface of each support member 120. Unlike the first embodiment in which the tabs 111 are bent outwards, in the second embodiment, both side edges 131 of each terminal 130 are bent in the tabside direction. Preferably, each side edge 131 of the terminal 130 is bent at 90°. The bent side edges 131 are brought into close contact with the corresponding tabs 111 and are subsequently joined thereto by resistance welding (S), thus completing the cell tab connection structure of the second embodiment.

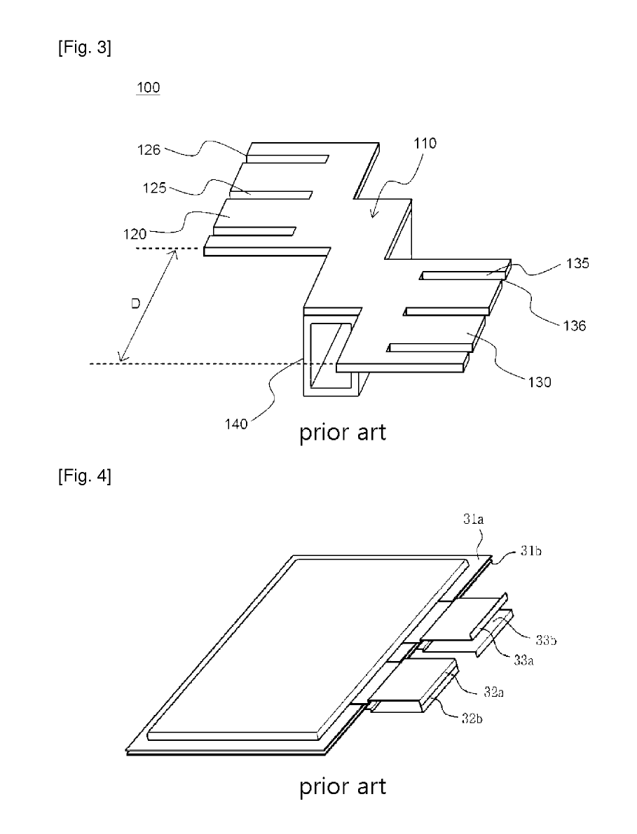

As described above, the connection structure between the cell tabs according to the present invention is embodied by the method of: bending the tabs 111 outwards in close contact with the corresponding terminals 130 or bending the both side edges 111 of the terminals 130 in the tab-side direction in close contact with the corresponding tabs 111; and joining the tabs 111 to the terminals 130 using resistance welding. In the present invention, each terminal 130 has a simple shape, for example, a planar shape. Therefore, compared to that of the connection members used in the conventional art of FIGS. 2 and 3, the process of manufacturing the terminal 130 can be simplified, thus markedly reducing the production cost. In other words, when the connection structure of the present invention is used, the production cost can be reduced and the productivity can be enhanced, because the shape of an element used as the connection member is simple compared to that of the conventional art.

Moreover, in the present invention, bringing the tabs 111 into contact with the corresponding terminals 130 only requires bending the tabs 111 or the two side edges 131 of the terminals 130. The conventional art wherein a method, such as bolt coupling or the like, is used requires a comparatively large number of elements or processes, for example, because a process of forming a through hole in each tab to insert a bolt into the tab is required. However, in the present invention, because it required just to bend the tabs 111 or the terminals 130, the process can be markedly simplified. Further, the joint between the tabs 111 and the terminals 130 is embodied by resistance welding (S). As such, the present invention does not need a separate element for joining them together, thus reducing the numbers of elements and processes to the minimum.

Furthermore, as mentioned above, because the cell tab connection process is very simple, the bending and welding processes may be conducted after the cells 100 are modularized (in other words, after the cells 100 are arranged in a desired shape). That is, after assembly of a cell module has been completed, the welding process can be conducted. Therefore, conditions under which the welding is conducted can be very stable. For example, in the conventional cell tab connection process using laser welding, the tabs are not put reliably in contact with the connector before the welding process is conducted which makes the error rate comparatively high. Unlike this, in the present invention, the welding process is conducted under a condition of stability, so that a welding error rate attributable to a defective connection between the tabs can be markedly reduced. Thereby, the productivity can be further enhanced.

Moreover, in the present invention, after the tabs 111 have been joined to the terminals 130 by resistance welding (S), not only the joining force derived from the resistance welding (S) is large but also the connection structure itself is formed in a stable shape which can resist external forces or the like. Hence, the structural stability of the completed battery 100 can also be markedly enhanced compared to that of the conventional art.

In FIGS. 5 through 10, although other elements or structures of the battery 100 are not illustrated in detail to focus on the cell tab connection structure, the cells 110 of the battery 100 are, of course, connected to external terminals of the battery 100 or a battery management system (BMS) as well as being connected to each other by the terminals 130. Here, the terminals 130 function not only to connect the tabs 111 to each other but also to enable the voltage between two adjacent cells 110 to be sensed in such a way that an external device is connected to the terminal 130 between the two cells 110, because the corresponding tabs 111 of the two cells 110 are electrically connected to the terminal 130.

As such, in the case where the terminals 130 are configured to enable voltage to be sensed between two cells, it is preferable that each terminal 130 be made of metal having a melting point of 600° C. or more to prevent it from being damaged by heat generated by high voltage. Phosphorous bronze is a representative example of a metal suitable to be used as the terminal having such characteristics. Phosphorous bronze has high conductivity, high abrasion resistance and high corrosion resistance so that it is very suitable for use as the terminal 130.

Furthermore, in the case of a metal such as phosphorous bronze, the melting point thereof is very high at about 970° C. Thus, when each terminal 130 is joined to the corresponding tabs 111 by resistance welding (S), power consumption for welding may be excessively increased. To prevent this, it is preferable that the terminal 130 be plated with metal including tin having a melting point of 600° C. or less. The melting point of tin is comparatively low at about 230° C., thus making the welding operation easy. Further, the ability to plate with phosphorous bronze is superior. Therefore, when the terminal 130 is made of phosphorous bronze plated with tin, not only the conductivity, the abrasion resistance and the corrosion resistance can be enhanced but also the welding operation can be facilitated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A battery having a cell tab connection structure using resistance welding, comprising a plurality of cells arranged in a predetermined pattern, each of the cells having a pair of tabs comprising a negative tab and a positive tab,
wherein each of tabs has a planar shape, and the tabs protrude outside one side of the cell and are configured such that a planar surface of the negative tab and a planar surface of the positive tab are parallel to and face each other,
the cells are arranged in at least one row in such a way that the planar surface of the negative tab of each of the cells faces parallel to the planar surface of the positive tab of the cell adjacent thereto,
a support member is interposed between the cells to support the cells, and
a terminal is placed on an upper surface of the support member, the terminal being made of an electrical conductor, and the tabs of each of the cells or both side edges of the terminal are bent, and the terminal is joined to the corresponding tabs of the cells by resistance welding.

2. The battery as set forth in claim 1, wherein
when a direction in which the tabs protrude from the cell refers to a “tab-side”,
the tabs of each of the cells are bent outwards, and the adjacent tabs between the cells are brought into close contact with the terminal placed on the tab-side surface of the support member interposed between the cells and are joined to the terminal by resistance welding.

3. The battery as set forth in claim 1, wherein
when a direction in which the tabs protrude from the cell refers to a “tab-side”,
the side edges of the terminal placed on the tab-side surface of the support member interposed between the cells are bent towards the tabs of the cells, are brought into close contact with the corresponding tabs, and are joined to the tabs by resistance welding.

4. The battery as set forth in claim 1, wherein the terminal is made of metal having a melting point of 600° C. or more.

5. The battery as set forth in claim 1, wherein the terminal is plated with metal having a melting point of 600° C. or less.

6. The battery as set forth in claim 1, wherein the terminal is used to sense voltage of the corresponding cell.

7. The battery as set forth in claim 1, wherein the terminal has a planar shape.

8. The battery as set forth in claim 1, wherein the support member is made of an electrical insulation material.

9. The battery as set forth in claim 1, wherein each of the tabs or each of the side edges of the terminal is bent to 90°.
